(19) United States
(12) Patent Application Publication
(10) Pub. No.: US 2007/0066286 A1
(43) Pub. Date: Mar. 22, 2007

(54) Inter-access mobility and service control

(76) Inventor: Tuija Hurtta, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/509,709

(22) Filed: Aug. 25, 2006

Related U.S. Application Data
(60) Provisional application No. 60/712,415, filed on Aug. 31, 2005.

(51) Int. Cl. H04Q 7/38

(52) U.S. Cl. 455/414.1

(57) ABSTRACT

The invention provides a method, system, network elements and computer programs, for providing service control. A Policy and Charging Rules Function, PCRF, sends rules for service control not only to a gateway but also to another network element such as a home agent, upon request, e.g. when a user equipment is registering to the network. The home agent preferably is a home agent of a Mobile Internet Protocol, IP, network.

### CROSS REFERENCE TO RELATED APPLICATIONS

This application claims priority of U.S. Provisional Patent Application Ser. No. 60/712,415, filed Aug. 31, 2005. The subject matter of this earlier filed application is hereby incorporated by reference.

### FIELD AND BACKGROUND OF THE INVENTION

The present invention relates to inter-access mobility and service control. Inter-access mobility is currently standardised in Third Generation Partnership Project Release 7, 3GPP R7.

Currently in 3GPP, service awareness is in the Gateway GPRS Support Node/Packet Data Gateway, GGSN/PDG. The relevant logical functions in the GGSN/PDG are called the Policy Enforcement Point (PEP) and the Traffic Plane Function (TPF).

In 3GPP, service control is performed by the Policy and Charging Rules Function (PCRF). This function contains the Policy Decision Function (PDF) and Charging Rules Function (CRF). In the following, this function is also called the IP Session Control (IPSC).

Technical Report TR 23.803 includes more information on 3GPP views on service awareness and service control.

A technical paper SRJ-050091 proposes a binding of permanent ID to IP address dynamically assigned by the Home Agent. Within the architecture in FIG. B.2a of this paper, the operator's IP services see only the IP address allocated by the mobile IP home agent. However, the PCRFs are working with the binding between the user's permanent identity (cf MSISDN) and the local IP address allocated by the GGSN (or its functional equivalent). If the MIP Foreign Agent is in the Evolved Packet Core, then the FA is probably aware of the IP address allocated to the mobile by the Home Agent, and, hence this could be sent to the PCRF. However, with other access technologies, the FA may well not be in the network and hence the PCRF is not aware of the address allocated to the mobile by the HA. This is likely to lead to charging problems at least for non-IMS services.

Currently, the PCRF communicates with one node, either with the GGSN or PDG. Currently, the GGSN/PDG uses the Care-of-Address of the user equipment, UE, as the binding mechanism when communicating with the PCRF. This is not enough in 3GPP R7.

A problem is how to perform service control when Mobile IP, MIP, is used for inter-access mobility. In such a case, for example, the MIP Home Agent (HA) may be used as a standalone logical element on Gi/Wi. This approach promotes Mobile IP (MIP) for inter-access mobility.

### SUMMARY OF THE INVENTION

The invention provides a method, system, devices, network elements, and computer programs as defined in the description, drawings or claims.

Preferably, service awareness may be provided in the MIP HA in addition to the GGSN/PDG.

The present invention proposes solutions for service control particularly when Mobile IP is used for inter-access mobility.

### BRIEF DESCRIPTION OF THE DRAWINGS

The invention will be described below in more detail with reference to the drawings.

FIGS. 1 to 6 show embodiments of the invention.

### DESCRIPTION OF EMBODIMENTS OF THE INVENTION

According to embodiments of the invention, initially, the nodes contact the PCRF with the pull mode. The pull mode has been standardised in 3GPP for the GGSN/PDG: the GGSN/PDG contacts the PCRF when a bearer is created/modified/deleted.

According to embodiments of the invention, the MIP HA may preferably contact the PCRF when receiving registration from the UE.

The IPSC preferably stores the addresses of all the nodes per IP session, so that it knows which nodes to contact if there is a need to push new service control decisions (the push mode). An IP session may be a bearer such as a PDP context or a WLAN security tunnel, or an IP flow.

In case of MIP, there are two type of IP addresses: the Home Address and the Care-of-Address. These addresses are bound in the MIP HA. The GGSN/PDG knows the Care-of-Address, whereas the Application Function (AF) in the application layer (e.g. the P-CSCF) knows the Home Address. The PCRF is supposed to collect input information from all the sources (e.g. GGSN, PDG, MIP HA, AF, Subscription Profile Repository (SPR)) and create service control decisions based on the input information. In order to enable binding all input information, this invention report proposes that the MIP HA sends both the Home Address and the Care-of-Address to the PCRF as binding information. This requires changes to the Gx+ interface in 3GPP.

Currently in 3GPP, the GGSN/PDG contacts the PCRF also at bearer deletion. The invention proposes that in the MIP HA, the same should happen at deregistration (i.e. when receiving a registration message with lifetime 0). The MIP HA thus informs PCRF at deregistration thereon. This way, the PCRF knows that the MIP HA is not anymore involved in the IP session.

The invention proposes that the PCRF allows service control requests from multiple sources for the same IP session (e.g. from the GGSN, PDG and MIP HA).

Initially, the nodes contact the PCRF with the pull mode. The pull mode has been standardised in 3GPP for the GGSN/PDG: the GGSN/PDG contacts the PCRF when a bearer is created/modified/deleted.

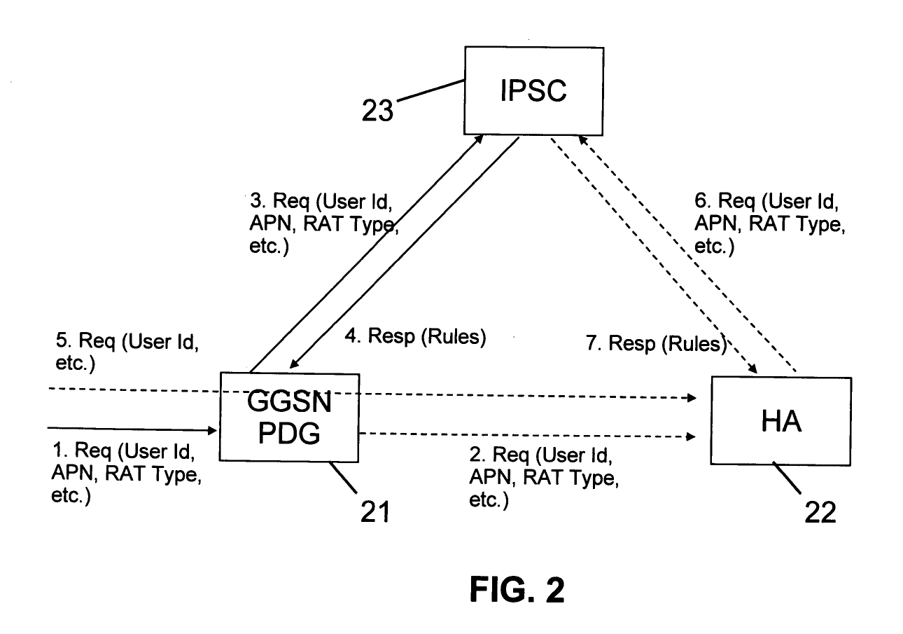

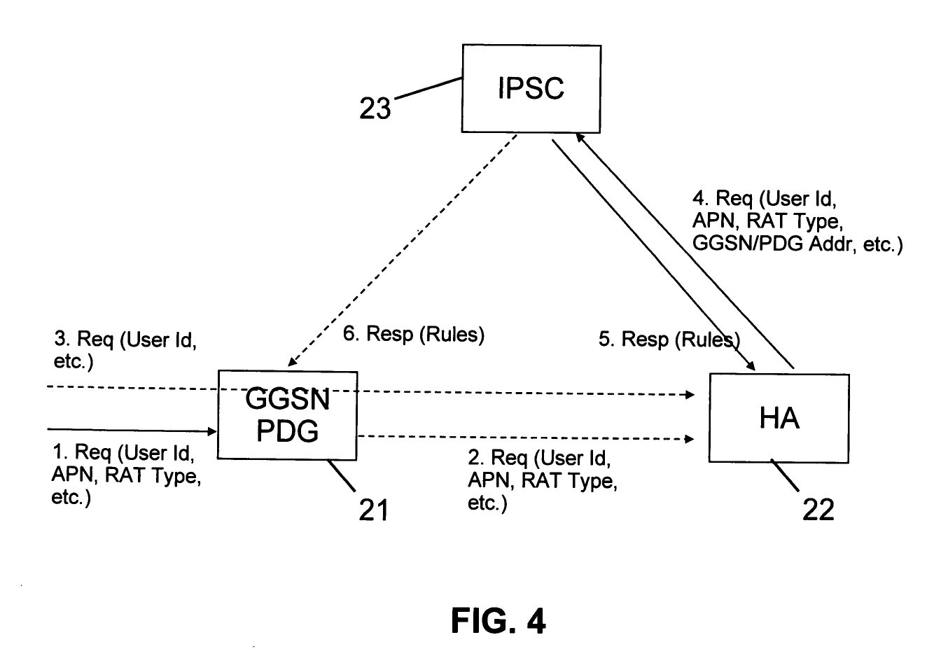

The invention proposes that the MIP HA preferably contacts the PCRF when receiving registration from the UE. Such embodiments are shown in FIGS. 2, 4.

The IPSC stores the addresses of all the nodes per IP session, so that it knows which nodes to contact if there is a need to push new service control decisions (the push mode).

In case of MIP, there are two type of IP addresses: the Home Address and the Care-of-Address. These addresses are bound in the MIP HA. The GGSN/PDG knows the Care-of-Address, whereas the Application Function (AF) in the application layer (e.g. the P-CSCF) knows the Home Address. The PCRF is supposed to collect input information from all the sources (e.g. GGSN, PDG, MIP HA, AF, Subscription Profile Repository (SPR)) and create service control decisions based on the input information. In order to enable binding all input information, this invention proposes that the MIP HA sends both the Home Address and the Care-of-Address to the PCRF as binding information. This requires changes to the Gx+ interface in 3GPP.

Currently in 3GPP, the GGSN/PDG contacts the PCRF also at bearer deletion. In at least one, some, or all of the embodiments of the invention, it is proposed that in the MIP HA, the same happens at deregistration (i.e. when receiving a registration message with lifetime 0). This way, the PCRF is informed at deregistration and thus knows that the MIP HA is not anymore involved in the IP session.

In some or all embodiments of the invention, the PCRF may communicate with multiple nodes per IP session.

The attached drawings show some embodiments of the invention. Embodiments for possible optimisations are also given.

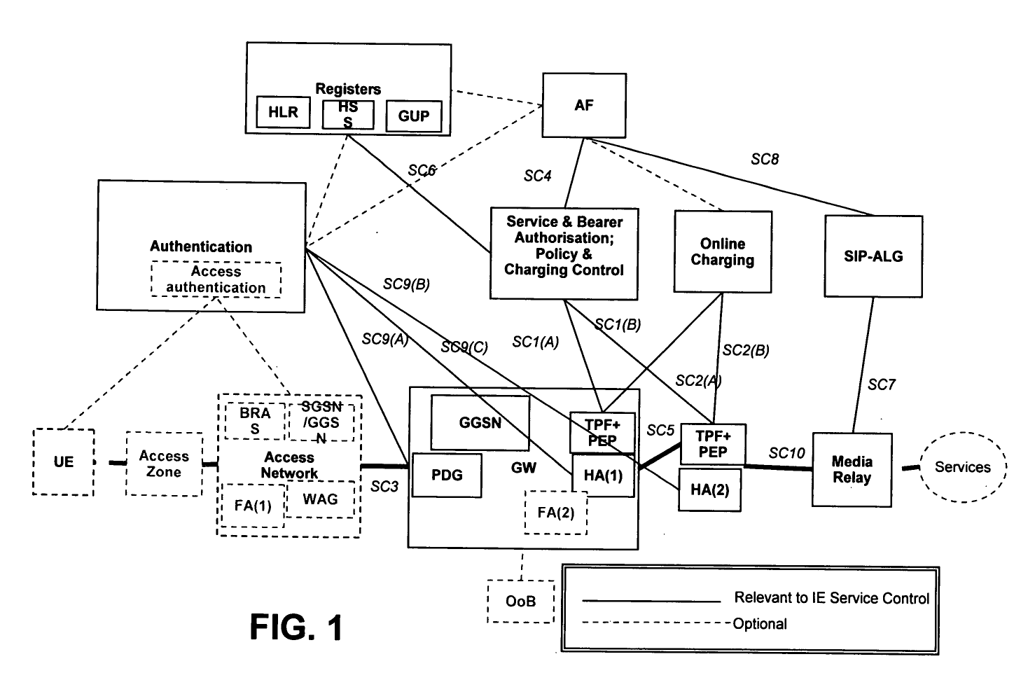

FIG. 1 shows an embodiment of a service control reference architecture which can be used in at least some or all embodiments of the invention.

A gateway GW consists of includes at least one of a GGSN and PDG. The GW communicates with a Service & Bearer Authorisation; Policy & Charging Control which may be implemented as a PCRF. The Service & Bearer Authorisation; Policy & Charging Control further communicates with a Home Agent HA which may correspond to at least one of HA(1) (implemented inside the Gateway GW), HA(2) (implemented outside the Gateway GW). A user equipment UE can be connected to, or communicate, with the GW via an access network in a known way.

FIG. 2 shows an embodiment of the invention. In this embodiment, both a GGSN/PDG 21 and a HA 22 are implemented to request rules from an IP Session Control, IPSC, 23. The IPSC provides service control. The service control may be based on, or correspond to, a Policy and Charging Rules Function, PCRF. The PCRF contains Policy Decision Function, PDF, and Charging Rules Function, CRF.

The GGSN/PDG 23 may be implemented as a combined GGSN and PDG, or may be either a GGSN or PDG alone.

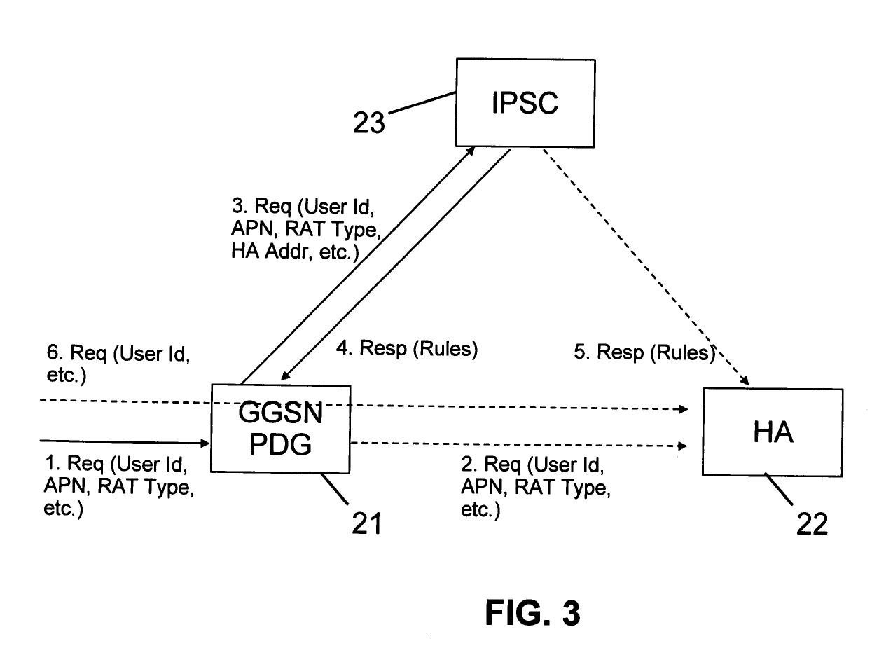

In this embodiment and also in other embodiments of FIGS. 3, 4, the IPSC 23 knows that both GGSN/PDG 21 and HA 22 are involved in the “IP Session”. The IPSC 23 will inform GGSN/PDG 21 and HA 22 if rules change.

In this embodiment, and optionally also in other embodiments such as shown in FIGS. 3, 4, both GGSN/PDG 21 and HA 22 preferably act as a gateway GW towards IPSC 23.

In a step 1., an IP session request Req (User Id, APN, RAT Type, etc.) is sent e.g. from a user equipment UE or the network, e.g. the access network or core network, to the GGSN/PDG 21. The IP session request Req may be e.g. a request for bearer creation such as PDP context activation or WLAN security tunnel setup, or identification of an IP flow. The request may preferably include information on the user ID, access point name APN, radio access technology RAT type, etc.

In a step 2., the GGSN/PDG 21 sends a request Req (User Id, APN, RAT Type, etc.) to the HA 22. The GGSN/PDG can do that if it knows the HA which will be contacted by the UE in a later step. In a step 3., the GGSN/PDG 21 sends a service control request Req (User Id, APN, RAT Type, etc.) to the IPSC 23. Step 3. may also be carried out essentially simultaneously with step 2. or prior to step 2.

In a step 4., the IPSC 23 responds to the service control request of step 3. by returning, to the GGSN/PDG 21 a service control response including information on the rules, Resp (Rules). These rules define, and are used e.g. to control QoS and/or charging of an IP session.

The HA 22 receives from the UE or the network, e.g. the access network or core network, a registration request which may include the information on the home address, care-of-address, user ID etc, as shown in step 5. The UE can thus be registered with the HA 22.

In a step 6., the HA 22 sends a service control request Req (Home Address, Care-of-Address, User Id, APN, RAT Type, etc.) to the IPSC 23. The service control request may include information on the home address, care-of-address, user ID, access point name APN, radio access technology RAT type, etc.

In a step 7., the IPSC23 responds to the service control request of step 6. by returning, to the HA 22, a message which includes information on the rules, Resp (Rules). These rules define, and are used e.g. to control QoS and/or charging of an IP session.

FIG. 3 shows a further embodiment of the invention in which the GGSN/PDG 21 is requesting rules from the IPSC 23 which are then sent to both the GGSN/PDG 21 and the HA 22. In this embodiment, the HA address of HA 22 is preferably resolved by GGSN/PDG 21 or IPSC 23.

In a step 1. of FIG. 3, an IP session request Req (User Id, APN, RAT Type, etc.) is sent e.g. from a user equipment UE or the network, e.g. the access network or core network, to the GGSN/PDG 21. The request may include the information on the user ID, access point name APN, RAT type, etc.

In a step 2., the GGSN/PDG 21 sends a request Req (User Id, APN, RAT Type, etc.) to the HA 22.

In a step 3., the GGSN/PDG 21 sends a service control request Req (User Id, APN, RAT Type, etc.) to the IPSC 23.

As shown in FIG. 3, the GGSN/PDG 21 may add, to the information received in step 1., the address of HA 22, HA Addr, when sending the service control request to the IPSC 23 in step 3. This information may also be sent in a separate message. In these cases, the GGSN/PDG 21 actively informs the IPSC 23 on the address of HA 22. The GGSN/PDG may know the address of HA by configuration or the address of HA may be included in the IP session request of step 1.

As an alternative the HA address may also already be known to, or may be resolved by, the IPSC 23. In this case, it is not necessary to add the HA address to the service control request of step 3.

In a step 4., the IPSC23 responds to the service control request of step 3. by returning, to the GGSN/PDG 21 a service control response including information on the rules, Resp (Rules).

Steps 1 to 4. of FIG. 3 may correspond to steps 1. to 4. of FIG. 2 as described above, apart from optionally sending the HA address, or adding the HA address to the message sent in step 3, as mentioned above.

In a step 5., the IPSC23 sends to the HA 22 a service control message which includes information on the rules, Resp (Rules). In this step 5., the IPSC 23 uses the HA address received in step 3., or resolved by the IPSC 23.

The HA 22 receives from the UE or the network, e.g. the access network or core network, a registration request which may include the information on the home address, care-of-address, user ID etc, as shown in step 6.

It is also possible that the UE never contacts the HA 22. In this case, the HA 22 may remove the rules e.g. at timer expiry.

FIG. 4 shows another embodiment of the invention in which the HA 22 is requesting rules from the IPSC 23 which are then sent to both the GGSN/PDG 21 and the HA 22. In this embodiment, the address of the GGSN/PDG 21 is resolved by the HA 22 or IPSC 23.

In this embodiment of FIG. 4, the GGSN/PDG 21 preferably knows that HA 22 will be used. In some cases, APN may indicate support for MIP, but it is still up to UE to use MIP.

In a step 1. of FIG. 4, an IP session request Req (User Id, APN, RAT Type, etc.) is sent e.g. from a user equipment UE or the network, e.g. the access network or core network, to the GGSN/PDG 21. The request may include the information on the user ID, access point name APN, RAT type, etc.

In a step 2., the GGSN/PDG 21 sends a request Req (User Id, APN, RAT Type, etc.) to the HA 22.

The HA 22 receives from the UE or the network, e.g. the access network or core network, a registration request which may include the information on the home address, care-of-address, user ID etc, as shown in step 3.

In a step 4., the HA 22 sends a service control request Req (Home Address, Care-of-Address, User Id, APN, RAT Type, etc.), to the IPSC 23.

As shown in FIG. 4, the HA 22 may add, to the information received in step 1., the address of GGSN/PDG 21, GGSN/PDG Addr, when sending the service control request to the IPSC 23 in step 4. This information can also be sent in a separate message. In these cases, the IPSC 23 is informed on the address of GGSN/PDG 21. The HA 22 may know the address of the GGSN/PDG 21 by configuration or if it received the request of step 2. It is also possible that the HA 22 resolves the address of the GGSN/PDG 21 from the care-of-address received in the registration request of step 3.

As an alternative the GGSN/PDG 21 address may also already be known to, or may be resolved by, the IPSC 23. In this case, it is not necessary to add the GGSN/PDG 21 address to the service control request of step 4.

In a step 5., the IPSC23 responds to the service control request of step 4. by returning, to the HA 22, a service control response including information on the rules, Resp (Rules).

Steps 1., 2., 4., 5. of FIG. 4 may correspond to steps 1., 2., 6., 7. of FIG. 2 as described above, apart from optionally adding the GGSN/PDG 21 address to step 4, as mentioned above.

In a step 6., the IPSC23 sends to the GGSN/PDG 21 a service control message which includes information on the rules, Resp (Rules). In this step 6., the IPSC 23 uses the GGSN/PDG 21 address received in step 4., or resolved by the IPSC 23.

After the pull mode, there may be a need to modify the rules sent earlier to the GGSN/PDG 21 and/or HA 22. If both are involved in the same IP session, the IPSC 23 stores the addresses of both the GGSN/PDG 21 and HA 22 and can thus inform them on modified rules when needed (the push mode).

The HA 22 contacts the IPSC 23 when deregistration of the UE is performed either by the UE itself or by the network, e.g. the access network or core network. This way, the IPSC 23 knows that the HA 22 is no longer involved in the IP session.

Generally, using Mobile IP provides reliable inter-access mobility. The HA, e.g. Mobile IP HA, can for example reside either in the gateway, GW, or outside the GW on Gi/Wi. Gi is an interface e.g. between a core network such as a GPRS core network, and Internet/intranet. Wi is an interface e.g. between a core network such as a WLAN interworking core network, and Internet/intranet. The Mobile IP HA may be implemented in the Gateway GW, shown as HA(1) in FIG. 1.

The MIP HA may be introduced as a logical function on Gi/Wi-HA(2) of FIG. 1.

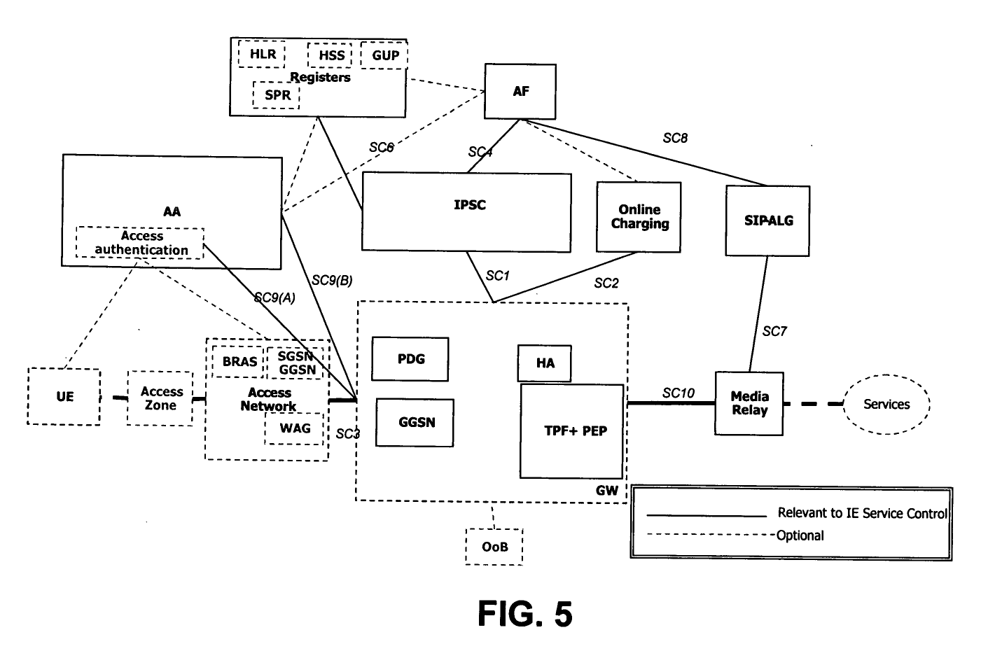

FIG. 5 shows another embodiment of the invention wherein only one Home Agent, HA, is shown. The structure of FIG. 5 can also be used with the embodiments of FIGS. 2 to 4 as described above.

Basically, the enhanced policy control and flow-based charging are specified in Release 6 standards. In Release 7 standards the development of a complete harmonization and merger of the policy control and flow based charging architecture is in progress. The merged policy and charging control (PCC) architecture allows the operator to perform service based QoS policy control and service based charging control with a single functional element called Policy and Charging Rules Function (PCRF). The PCRF has also interface to the Subscription Profile Repository (SPR) for adding end user subscription differentiation.

The unified PCC architecture will allow the control of all kinds of services, both session based and non-session based, and is targeted for any kinds of bearers from any IP Connectivity Access Network (IP-CAN). As the focus of the system architecture evolution is on packet-optimized system that supports multiple Radio Access Technology (RAT) types and all kinds of services, including voice services, the PCC architecture is a valuable building block in the overall system architecture.

The present invention proposes some solutions for the key issue Policy Control and Charging, and the role of PCRF in the evolved system architecture.

For the most part, the Policy and Charging Control architecture specified in Release 6 and further developed for Release 7 is sufficient in the context of the evolved system architecture. The main new factors to be considered when discussing the PCC architecture are the nature of the gateways connected to the PCRF; the handling of PCC in roaming situations; and the means to simplify policy control in line with simplification elsewhere in the evolved system architecture.

Considering the connectivity of the PCRF to other network elements, the control authority should be unambiguous. Therefore, each separately controllable piece of communications, such as a single IP flow or an aggregate of IP flows, will be controlled by a single PCRF, whereas the enforcement of that control and charging can take place in the Policy Enforcement Point (PEP) and Traffic Plane Function (TPF) of multiple network elements along the path taken by the communications. Similarly, each PEP/TPF may be controlled by multiple PCRFs.

The Rx+ reference point between PCRF and Application Function (AF), and the Sp reference point between PCRF and SPR are used as in Release 7 PCC. The PCRF connection to the operator's IP Gateway(s) with the Gx+ reference point is also in line with current architecture. These reference points can be updated according to potential additional requirements of the evolved system separately from Release 7 PCC standardization process, and while maintaining compatibility with the current PCC architecture. The main addition is the use of the Gx+ reference point also with the Inter-Access System Mobility Management (Inter-AS MM) network element in the HPLMN in order to avoid changing the controlling PCRF when UE roams between access systems. Accordingly, the PEP/TPF can be in an IP Gateway, and in the Inter-AS MM network element of the HPLMN. The Inter-AS MM may be implemented e.g. as a function in the HPLMN IP Gateway, similar to GGSN.

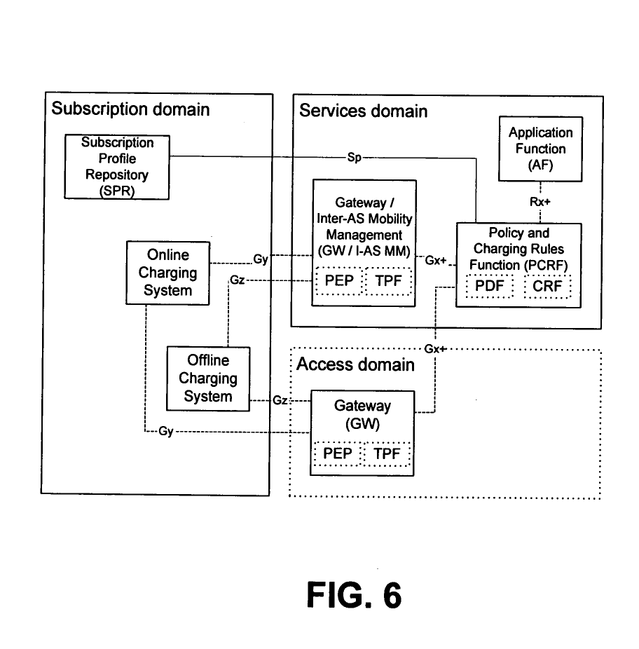

FIG. 6 shows an embodiment of or usable with the invention which illustrates PCC related interfaces between network elements in the evolved system. The below description basically refers to FIG. 6 but is also applicable to the embodiments of FIGS. 1 to 5.

The IP Gateway selects a PCRF for the subscriber based on the UE identity, and its configured connectivity information. In roaming situations, this allows an IP Gateway containing Inter-AS MM to choose the same authoritative PCRF regardless of the VPLMN or access system of the UE.

The PCRF does not provide roaming interfaces. Instead, the IP Gateway in a VPLMN receives a set of default policy and charging rules tied to the end user's subscription as part of the initial authorization of the subscriber. This takes place over the AAA framework separate from the PCC architecture. Such policies may control the selection of a PCRF for the subscriber, the provision of services (including Internet breakout) in the visited network, or the forwarding of subscriber traffic to the HPLMN IP Gateway. The subscriber is not expected to change PLMNs frequently, meaning that the delivery of rules using the initial authorization process will not significantly degrade performance experienced by the end user. The rules delivered in this fashion are expected to be static, e.g. gating of particular services.

Flow-based policies and charging are applied in the IP Gateway or Inter-AS MM of a PLMN providing operator services. The roles of these network elements are unchanged despite roaming by the subscriber initiating the flow, i.e. the initiation phase control plane traffic and some of the user data traffic always passes through them.

In order to support policing and charging of subscriber's resource consumption spread across multiple access and service networks while using a single PCRF to control each session or other end-to-end communications unit, the amount and complexity of rules applied in visited networks should be minimized. One way to do this is to handle the policing and charging of bulk data traffic as part of a default access service tied to the subscription. In this case, the rules should refer to unambiguous (standardized or compliant with an inter-operator agreement) service types and be used without the involvement of PCRF.

The rules preferably are RAT independent but may contain RAT specific values for application by the IP Gateway. The IP Gateway can provide RAT information to the PCRF as in Release 7 Gx+ interface, with updates to RAT values for new access types.

The use of PCC to control any new functions is an open issue and depends on the decisions made in other areas of the system architecture evolution work.

The proposed solution relates as follows to PCC issues list.

PCRF/TPF relates to Multi-access support of SAE work as follows. Release 7 PCRF is designed for any IP network. RAT information is provided to PCRF as in Release 6 Gx or Release 7 Gx+ interface with updated RAT values. PCRF can provide RAT specific values in generic rules to TPF in order to support multi-access. The Gx+ interface may terminate in IP Gateway, and in Inter-AS MM network element.

IP Gateway may translate generic RAT independent rules to RAT specific rules with RAT specific values provided by PCRF. The PCRF does not provide roaming interfaces. The use of PCRF in inter-AS mobility requires connection to Inter-AS MM.

The proposed architecture is able to meet the current protocol(s) requirements for PCC to cover roaming and/or non-3GPP access systems.

As in Release 7 PCC architecture, the IP Gateway can select a PCRF for each subscriber based on the UE identity and its own configured connectivity information (for GPRS access APN may be selection criteria as well). The same PCRF is selected as long as the UE identity remains the same across the RATs or access systems through which it accesses the IP Gateway.

Therefore, an IP Gateway serving multiple access systems can consistently select one of a number of multi-AS capable PCRFs for a subset of subscribers.

If the PCRF is connected into one of the packet core networks then PCRF needs to be connected to all of them, otherwise, only part of the data flows are charged for.

The interface is required to all participating IP Gateways, including the Inter-AS MM.

The PCC architecture follows that specified for Release 7, including Rx+ and Sp reference points. The PCRF is connected to the IP Gateway(s) and Inter-AS MM in the HPLMN with the Gx+ reference point. TPF is in the IP Gateway or Inter-AS MM of a PLMN providing operator servicesDefault subscription-based rules may be transferred over the AAA framework from relevant subscriber databases such as SPR to the IP Gateway without

PCRF involvement as part of the initial authorization procedure. There can be multiple instances of TPF and PEP controlled by a single PCRF.

Release 7 PCC work is used as the basis for PCC in SAE context, and there should not be any conflicts with the Release 7 PCC functionality.

The requirements of PCC are addressed by the adoption of the Release 7 PCC architecture as the basis for PCC in the evolved system.

The PCRF may be selected based on UE identity and IP Gateway configuration.

The TPF is in the IP Gateway or Inter-AS MM, which has the information such as IP 5-tuple and other information (i.e. conveying same information as current APN).

There is no additional delay for use of operator services because the PCRF is connected to the IP Gateway of the PLMN where they are provided. The enforcement of rules in the initial access context takes place in the IP Gateway of the VPLMN and also causes no additional delay. Neither is there additional delay for non-roaming subscribers.

In the case of flow based QoS and charging between subscribers roaming outside of their HPLMN, the Inter-AS MM introduces no additional session initiation latency. However, enforcement of flow based rules in the PEP of the Inter-AS MM might add route delay to otherwise route optimized traffic.

In embodiments of the present invention, the Policy Control and Charging in the evolved system is presented. It is preferably but not necessarily based on the Policy and Charging Control architecture specified in Release 6 and further developed for Release 7, with the addition of an Inter-AS MM alongside IP Gateway as a network element containing PEP and TPF, and controlled by PCRF over Gx+ reference point. Besides service-based policies transferred over PCC architecture, subscription-based policies such as those defining basic IP connectivity are preferably separately transferred as part of initial authorization of the subscriber.

For providing a solution for key issue Policy control and Charging, it is preferably possible to inform the PCRF what radio access technology a subscriber is utilizing since depending on operator configuration it may influence what policy control and charging rule is being activated by a PCRF. The PCC interfaces already defined in Rel-7 may be used as a basis in an SAE context and may be evolved to meet SAE requirements. The PCC functionality preferably is able in an effective way be able to handle different QoS models cf. e.g. I-WLAN vis-à-vis WCDMA.

In a B2 context, the PCRF is preferably connected to the IP Gateway and the Inter-AS MM. The Inter-AS MM may be a function of the IP Gateway in subscriber's HPLMN. The PCRF is also connected to AF as in Release 7 PCC specification. When the subscriber roams to a new IP Gateway, default subscription-based policy control and charging rules are preferably transferred as part of the authentication and authorization process.

The IP Gateway can select a PCRF for each subscriber based on the UE identity and its own configured connectivity information as in Release 7 PCC architecture. The same PCRF is selected as long as the UE identity remains the same across the RATs or access systems over which the UE accesses the IP Gateway.

The IP Gateway preferably sets a default QoS level and charging treatment for each subscriber's aggregate data traffic at the time of initial authorization. These rules are transferred from SPR to the IP Gateway. The QoS mechanism can be e.g. DiffServ.

The PCC rules are generic, with RAT specific parameter values, as in Release 7 PCC.

Data volume collection is preferably performed in the IP Gateway. The IP Gateway uses the data to create charging information for the charging system.

FBC can be deployed in the IP Gateway or Inter-AS MM of a PLMN providing operator services.

The scope of the invention is not restricted to the above embodiments but also encompasses implementations having only some or changed or additional features.

1. A method for providing service control, the method comprising:
storing rules for service control in a first network element;
sending the rules from the first network element to a gateway and to a second network element upon request.

2. The method according to claim 1, wherein the step of sending comprises sending the rules to a home agent.

3. The method according to claim 1, wherein the first network element comprises or implements a Policy and Charging Rules Function (PCRF).

4. The method according to claim 3, wherein the PCRF contains a Policy Decision Function (PDF) and Charging Rules Function (CRF).

5. The method according to claim 1, comprising sending the request from both the gateway and the second network element.

6. The method according to claim 1, comprising sending the request only from the gateway.

7. The method according to claim 1, comprising sending the request only from the second network element.

8. The method according to claim 1, wherein the second network element informs the first network element upon deregistration of a user equipment from the second network element.

9. The method according to claim 1, wherein the gateway informs the second network element on registration or deregistration of a user equipment to or from the gateway.

10. A system for providing service control, the system comprising:
a first network element;
a second network element; and
a gateway;
wherein the first network element is configured to store rules for service control, and to send rules to a gateway and to the second network element upon request.

11. The system according to claim 10, wherein the second network element comprises a home agent, and/or the first network element comprises or implements a Policy and Charging Rules Function (PCRF).

12. The system according to claim 10, wherein the request is sent from both the gateway and the second network element, the request is sent only from the gateway, or the request is sent only from the second network element.

13. The system according to claim 10, wherein the second network element is configured to inform the first network element upon deregistration of a user equipment from the second network element, and/or the gateway is configured to inform the second network element on registration or deregistration of a user equipment to or from the gateway.

14. A network element storing rules for service control, the network element being configured to send the rules to a gateway and to another network element upon request.

15. The network element according to claim 14 wherein the network element comprises or implements a Policy and Charging Rules Function (PCRF).

16. A gateway which is configured to send, when receiving a registration request, the registration request to a network element storing rules for service control, and to send additional address information to the network element, the additional address information informing the network element of an address of a second network element to which the rules for service control are to be sent.

17. The gateway according to claim 16, wherein the gateway is configured to include the additional address information in the registration request before sending it to the network element.

18. A network element which is configured to send, when receiving a registration request, the registration request to a second network element storing rules for service control, and to send additional address information to the second network element, the additional address information informing the second network element of an address of a gateway to which the rules for service control are to be sent.

19. A network element which is configured to send, when receiving a deregistration request, information to a second network element storing rules for service control, for informing the second network element of the deregistration.

20. The network element according to claim 18 or 19, wherein the network element comprises a home agent.

21. A computer program product embodied on a computer readable medium and loadable into a gateway or a network element, wherein, when the computer program is executed, the following steps are performed:
storing rules for service control in a first network element;
sending the rules from the first network element to a gateway and to a second network element upon request.

22. The method according to claim 2, wherein the home agent comprises a home agent of a Mobile Internet Protocol Network.
